(19) United States
(12) Patent Application Publication
(10) Pub. No.: US 2006/0259346 A1
(43) Pub. Date: Nov. 16, 2006

(54) Trolley tracker

(75) Inventor: Jacqueline Ingrid Williamson, Lonehill (ZA)

Correspondence Address: LAHIVE & COCKFIELD, 28 STATE STREET, BOSTON, MA, 02109, US

(73) Assignee: Inperspective Research Consultancy, Lonehill (ZA)

(21) Appl. No.: 10/559,019

(22) PCT Filed: May 26, 2004
(86) PCT No.: PCT/IB04/01722

§ 371 Date: May 16, 2006

(30) Foreign Application Priority Data
May 26, 2003 (ZA) 2003/4055

(51) Int. Cl. G07G 1/00

(52) U.S. Cl. 705/10; 340/5.9; 340/568.5

(57) ABSTRACT

A plurality of transponders are attached to a plurality of trolleys and/or shopping baskets. Each of the transponders has a unique identity encoded therein. At least one detector is located in the store, the detector being adapted to detect the location of the plurality of transponders in the store at various times. A central server is adapted to receive information from the at least one detector or the plurality of transponders. The information at least includes the unique identity of at least one transponder detected and a time and location at which the transponder was detected within the store. This information is used to map the route of at least one consumer through the store.

### BACKGROUND OF THE INVENTION

This invention relates to a system for mapping the route of a consumer through a store.

The route of a consumer through a store is very important market research information as very little information is available about what happens at the point of purchase. The information is used by retailers to optimise store layouts and by manufacturers to understand purchase repertoires and determine various sorts of promotional information.

Until now, the route of a consumer through a store has been mapped manually with the retailer employing market researchers either to follow various consumers around the store mapping the route as they go or by setting up video cameras at various locations around the store. The video information can then be watched to map the route of a consumer through the store.

The above methods are restrictive in that they require large amounts of personnel time to map the route, either as the consumer walks the route or afterwards by watching the video. Due to this limitation, it will be appreciated that not all consumer's routes are mapped which would require a large amount of resources.

It is an object of the present invention to provide an improved system for mapping the route of a consumer through a store.

### SUMMARY OF THE INVENTION

According to the present invention there is provided a system for mapping the route of a consumer through a store, the system comprising:
a plurality of transponders attached to a plurality of trolleys and/or shopping baskets, the plurality of transponders each having a unique identity;
at least one detector located in the store, the detector being adapted to detect the location of transponders in the store; and
a central server adapted to receive information including at least the unique identity of at least one transponder detected and the location and time at which the transmitter was detected, the central server being further adapted to store the received information in an associated memory means, which information can be used to map the route of at least one consumer through the store.

The system may comprise a plurality of detectors located at various positions around the store, wherein each detector is adapted to detect when at least one of the plurality of transponders is within a predetermined proximity to the detector and wherein each of the plurality of detectors has a unique identity

In this case, the unique identity of a detector is transmitted from the detector to the central server together with the identification of a transponder which is within the predetermined proximity to the detector.

In one embodiment, the time and location of a transponder is stored in a memory means associated with the transponder and downloaded from the transponder to the central server.

Preferably, detectors will be located at various points along the aisle as well as at each check-out/till point to detect when a transponder is within a predetermined proximity to the check-out/till point.

More preferably, purchased product information from each check-out/till point is also transmitted to the central server together with the identity of a detected transponder which is within the predetermined proximity to the check-out/till point.

The purchased product information and the identity of a detected transponder which is within the predetermined proximity to the check-out/till point may be stored in the associated memory means.

### BRIEF DESCRIPTION OF THE DRAWING

The FIGURE is a schematic illustration of the system of the present invention installed in a store.

### DESCRIPTION OF EMBODIMENTS

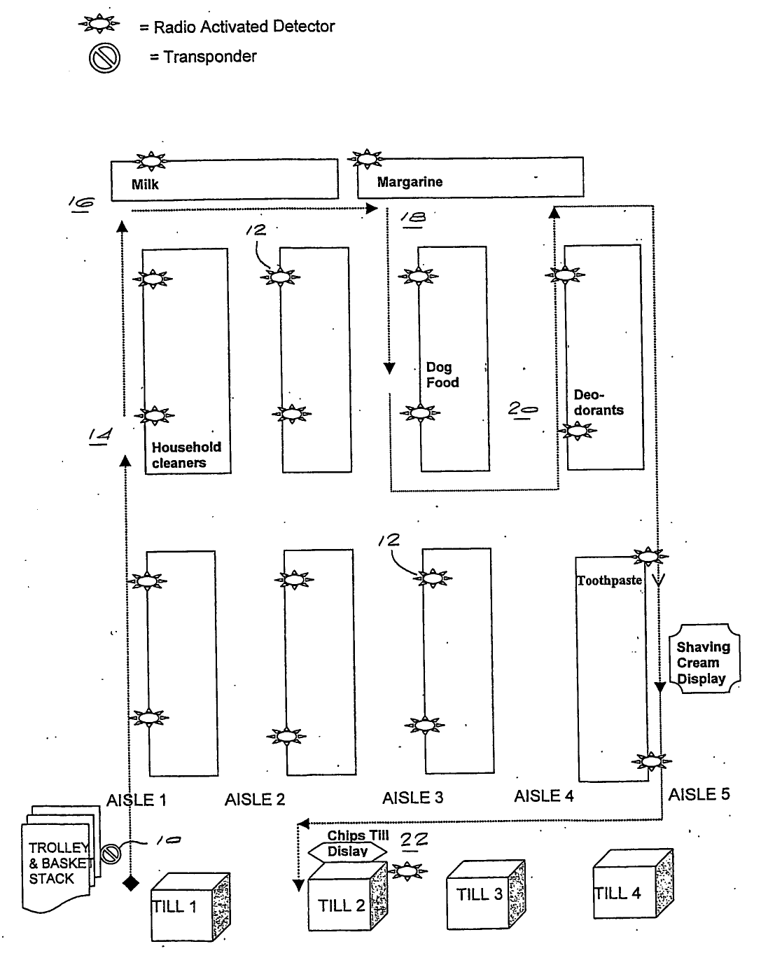

Referring to FIG. 1, a plurality of transponders 10 are attached to a plurality of trolleys and/or shopping baskets. The transponders 10 may be active or passive transponders. Each of the transponders 10 has a unique identity encoded therein.

A plurality of detectors 12 are located at various positions around a store. Each of the detectors 12 are adapted to detect when at least one of the plurality of transponders 10 are within a predetermined proximity to the detector 12. Obviously, if a particular transponder 10 is within a predetermined proximity to a detector 12, the trolley or shopping basket to which the transponder is attached is also within the predetermined proximity to the detector 12. The predetermined proximity is determined by the range of detector 12, which may vary in range but will be set to approximately 3 meters on average.

The detectors and transponders of the present invention are Radio Frequency (RF) detectors and transponders and use a combination of RF and GRPS technology to transmit information. It will be appreciated that cellular technology may also be used as an alternative.

A central server (not shown) is adapted to receive information from the plurality of detectors 12. The information at least includes the unique identity of a detector together with the unique identity of at least one transponder detected within the predetermined proximity to the detector and a time at which the transponder was detected within the predetermined proximity.

Practically, the central server will be receiving information from a number of the detectors 12 which will continually be detecting various transponders coming in and going out of range of the detectors.

The central server will typically have memory means in the form of a database, for example, associated with the central server and in which the central server will store all of the received information. This information is what will be used to map the route of at least one consumer through the store.

The central server may be located at the store premises or may be located remotely, possibly with an intermediate server located at the store premises to receive the data from the detectors 12 and to transmit this data on to the central server.

It is envisaged that the plurality of detectors 12 are connected to the central server by means of a communications network which may be hard wired or wireless, such as radio communications networks or networks based on blue tooth technology.

FIG. 1 includes an example path of a consumer illustrated using dotted lines and arrows.

The consumer enters the store and walks up aisle 1. As the trolley or shopping basket which the consumer is using passes the detectors in aisle 1, the detectors detect that the trolley or basket is moving up the aisle.

The consumer stops at the household cleaners section 14 for a few minutes, where they are obviously selecting household cleaners.

The consumer then travels up the remainder of the aisle and stops at the milk fridge 16.

The consumer continues along the top of the store where they are detected stopping at the margarine fridge 18 before moving down aisle 3 and being detected by the detectors located in this aisle.

The consumer is next detected passing the deodorant counter 20 and moving up aisle 4, before moving down aisle 5, past the toothpaste and shaving cream display and towards till number 2 where they are detected by the transponder located at the till 22. In practice, a detector 22 will be located at each check-out/till point in the store.

A portion of the information received by the central server may look as follows:

Transponder No. 123=Trolley

Date=21 May 2003, Day=Wednesday, Time=12.23 pm

Entered Aisle 1 . Time=12.24,08

Stopped at Household Cleaners Time Arrive=12.25.25 . . . Left=12.27.02

Stopped at Milk, Fridge 1, Time=12.28.01 . . . Left-12.30.09

Stopped at Aisle 3, Fridge 2, Time=12.31.04 . . . Left=13.33.04

It will be appreciated that not only have the detectors transmitted to the central server the time of arrival of the transponder in the proximity of the detector, but also the time that the transponder left the proximity of the detector. This enables the system user to determine how long the consumer stopped at a particular location in the store.

In a second embodiment of the present invention, a single detector 12 is used which is able to determine the location of the transponders in the store. The store layout map is overlaid onto a graphical interface in the form of a matrix. The matrix plots the ranges of each of the detailed shop areas so that one can determine the exact location of a transponder relative to the detailed shop area. This may be done by measuring the relative distance of the transponder and plotting the x-y co-ordinates on the matrix.

Alternatively, a triangular approach using telemetry may be used. In this embodiment only 3 or 4 detectors are needed. Using a similar approach to that described above, the exact location of the transponder is able to be pinpointed by measuring the relative positioning of the transponders in the store and overlaying this onto a graphical depiction of the store layout. This approach enables information to be collected from a number of detectors and the information to be transferred either via the transponders or directly from the detectors.

It will also be appreciated that in any embodiment described above, the information can be transmitted to the central server by the detectors themselves as has been described. Alternatively, the location of each transponder and the associated time can be stored in a memory means associated with the transponder and downloaded from the transponder to the central server at a future point in time.

In this case, the transponder will record where the shopper goes in the store, the route that they take through the store and how long they spend at each point of purchase, typically in seconds.

In an enhancement to the above embodiments, the purchased product information detected by the check-out/till point, namely the items which are scanned through the till/check-out or till transaction number, is also transmitted to the central server together with the identity of the transponder which has been detected in the vicinity of the check-out/till point at that time.

This allows the system to not only ascertain which route through the store the consumer travelled, but to ascertain what the consumer actually purchased. This information is also transmitted to the central server via a communications network and stored in the memory means together with the other information, as detailed above. In this way, the shoppers journey can be linked to what they buy.

It is envisaged that the transfer of information from the check-out/till point to the central server could occur in one a number of ways.

For example, the check-out/till point logs the purchased product information together with the transaction number and the time that the information is entered into the till/check-out. This information is then transmitted to the central server which uses the time and till transaction number to link the purchased product information to the information stored for the trolley or basket transponder which was detected at that till at the same time. Alternatively, the transponder may read the till transaction number. The transaction data from that particular till transaction number is then supplied by the retailer at a later date and merged with the tracking data.

The system of the present invention is also further enhanced by identifying the consumer using shopper identification means. This can be achieved by running promotions whereby vouchers are distributed to consumers having particular demographics, such as to all the men, so that when the vouchers are redeemed at the tills, an indication can be transmitted to the central server that the consumer is male. Alternatively, a loyalty card database, in-store cameras, fingerprinting mechanism or face recognition software which identifies consumers and allocates them a number to determine repeat behaviour can be used.

This will enable the monitoring of segment shoppers to ascertain their behaviour and monitor how often they come into the store, what they typically buy, how much they spend etc. Based on this information, it can be determined what will get shoppers to spend more and/or shop in the store more often. For example, the impact of broadsheet advertising can be measured on shopping trends and whom it is likely to attract.

In addition, a predictive model can be built which will enables the simulation of the effect of store changes on shopping behaviour without having to physically change the store layout.

In a further embodiment, each trolley or basket is fitted with a small display screen which advertises brands on promotion in the store when the trolley passes a particular detector. This is then used to alert the shopper to specials/promotions in the store as he/she approaches the relevant category. The specials/promotions advertised on this display change as the shopper moves through the store.

Once the information has been gathered, reporting software allows reporting on the data to be carried out revealing various forms of information. For example, the data can be sorted into events and shoppers in the following structure:
By country, region, area and suburb
By channel, chain and by individual store
Within store:
By tag (trolley or basket)
By department in-store
By High Level Shop Area and Detailed Shop Area
By Shop Section and by Aisle
The category hierarchy is structured according to the National Product Library of that particular Chain. This could be modified to suit the needs of different category classifications used by manufacturers
By product classification, category, brand, variant, pack size and price
By type of shopping trip (derived from a cluster analysis of amount of the store shopped, sections and categories shopped and whether they had a trolley or basket)
By Point of purchase type (main shelf, display, promotion, gondola end, fridge etc)
By various time periods (time of day, day of the week, day of the month, mid month vs. month end etc)

The invention provides a number of useful marketing research information:
Traffic counts of consumers passing a particular point of purchase/shopping an aisle
Which aisles are ‘shopped’
Of the consumers passing a particular point of purchase, how many stop and consider buying the category
Which brand is bought in each category (this is determined from the till transaction data)
How long the shopping trip takes
How long consumers spend at each point of purchase
On what day of the week and during what time in the month the shopping trip is made

This information can be used by the retailers to optimize the store layout and by manufacturers to maximize their category exposure by determining:
The route consumers shop and how this varies by the type of shop they are doing (month-end vs. top up shop)
Hot spots and dead areas in the store
Which are high traffic areas in the store and which are high conversion points
Which are planned vs. impulse purchase categories (i.e. high % of consumers stopping at the category purchase from it, and areas where items are purchased en route vs. made a specific trip to that aisle)
Which categories are shopped first when consumers come into the store
How many lost sales are there to the category (i.e. consumers who consider the category but don't purchase anything).
Identifying cross merchandising opportunities
Understand the role of ends/displays and where is the optimal place to position them in-store, thereby reducing clutter, increasing sales and improving the shopping experience
Establish when is the best time to run promotions
Determine the traffic passing each category and conversion into sales as well as the extent of lost sales in each category
Measure the impact of broadsheet advertising on the advertised category and the impact it has on sales of other categories
Determine what types of shopping trips are typically done in the store and how much of total shopping trips they account for

The information can also be used by manufacturers to obtain the following information:

Effectiveness of Promotions:
How many consumers pass a particular display?
Of those who pass a display how many actually buy from this display?
How many purchase from the category on promotion, but buy from the main shelf rather than from the display?
When is the best time to have a promoter lady in the store?
When is the best time of the month to run promotions on their brand?
Does broadsheet advertising increase consideration for the category?
Do more people shop the category when there is a promotion on?
Do they interrupt the shopper and prompt them to purchase or do they act as a reminder to visit the category?
   During What Type of Shop is Their Product/Brand Typically Bought?
Month-end shop vs. top up shop
What is the average basket size when their product/brand is purchased
   Purchase Repertoires
Which products are bought with their product/brand on the same trip (this has implications for cross merchandising)
   How Much of the Store is Shopped When the Brand is Purchased?
Does the consumer shop all the aisles or only certain ones when buying product/brand X?
Is this product category shopped first when the consumer comes into the store or is it purchased on route? (i.e. role of the category).

1. A system for mapping the route of a shopper through a store, the system comprising:
a plurality of transponders attached to a plurality of trolleys and/or shopping baskets, the plurality of transponders each having a unique identity;
at least one detector located in the store, the detector being adapted to detect the location of transponders in the store; and
a central server adapted to receive information including at least the unique identity of at least one transponder detected and the location and time at which the transmitter was detected, the central server being further adapted to store the received information in an associated memory means, which information can be used to map the route of at least one shopper through the store, the central server being further adapted to receive purchased product information from a check-out point together with the identity of a detected transponder which is in proximity to the check-out point and to store the purchased product information and the identity of the detected transponder which is in proximity to the check-out point in the associated memory means.

2. A system according to claim 1 comprising a plurality of detectors located at various positions around the store.

3. A system according to claim 2 wherein each detector is adapted to detect when at least one of the plurality of transponders is within a predetermined proximity to the detector and wherein each of the plurality of detectors has a unique identity

4. A system according to claim 3 wherein the unique identity of a detector is transmitted from the detector to the central server together with the identification of a transponder which is within the predetermined proximity to the detector.

5. A system according to any of claims 1 to 3 wherein the time and location of a transponder is stored in a memory means associated with the transponder and downloaded from the transponder to the central server.

6. A system according to any preceding claim wherein detectors are located near each check-out point to detect when a transponder is within a predetermined proximity to the check-out point.

7. A system according to any preceding claim further comprising shopper identification means to identify a shopper using a particular trolley or basket to which a transponder is attached.

8. A system according to claim 7 wherein the shopper identification means is at least one of a loyalty card database, in-store cameras, fingerprinting mechanism or face recognition software.

9. A system according to claim 7 or claim 8 wherein the system is adapted to allocate a number to a shopper based on their Identification and to save the number in the memory means associated with purchased product information to allow monitoring of the shopper's behavior over a period of time.

10. A system substantially as herein described with reference to the accompanying drawings.
